(19) United States
(12) Patent Application Publication
(10) Pub. No.: US 2024/0109754 A1
(43) Pub. Date: Apr. 4, 2024

(54) EMERGENCY EVACUATION ROBOT

(71) Applicant: Otis Elevator Company, Farmington, CT (US)

(72) Inventor: Okan Uslu, Istanbul (TR)

(21) Appl. No.: 17/988,493

(22) Filed: Nov. 16, 2022

(30) Foreign Application Priority Data
Sep. 29, 2022 (EP) 22198893.4

(51) Int. Cl. B66B 5/02; B66B 1/34

(52) U.S. Cl. CPC B66B 5/027; B66B 1/3461

(57) ABSTRACT

A robot (150) and a method of rescuing passengers (160) from an elevator system (101) using at least one robot (150). A robot (150) capable of moving around at least a part of a building including an elevator landing area (125), the robot (150) configured to interact with an elevator system (101) in the building; the robot (150) configured to receive at least one emergency notification from the elevator system (101); and the robot (150) configured to interact physically with the elevator system (103) as part of a rescue operation.

### FOREIGN PRIORITY

This application claims priority to European Patent Application No. 22198893.4, filed Sep. 29, 2022, and all the benefits accruing therefrom under 35 U.S.C. § 119, the contents of which in its entirety are herein incorporated by reference.

### TECHNICAL FIELD

This disclosure relates to a robot assisting with a rescue operation from an elevator system during an emergency. In particular, the method and robot disclosed herein may be used to help with evacuation of passengers from an elevator car during a rescue operation.

### BACKGROUND

Safety within an elevator system is of utmost importance at all times. Whilst there are numerous systems in place aimed at preventing an emergency from occurring, on occasion faults within the elevator system might cause various emergency situations. A common occurrence in such situations is that passengers can become trapped in an elevator car in the hoistway.

It is known in the art for passengers to use an emergency button to activate an alarm and contact maintenance when they become trapped in an elevator car. However, in most buildings, there is no on-site maintenance personnel, and trapped passengers must await a maintenance person's arrival to be rescued. Elevator cars can be small and confined spaces, and passengers can have increased anxiety and fear when trapped in an elevator car without knowing when they will be rescued. Some elevator alarms provide for some form of communication with a call centre which can provide some information and reassurance to the passengers. However, even with such communication links, passengers can sometimes be left with little information for long stretches of time. Such scenarios can be very stressful for passengers, and can cause additional concerns for their safety. It is desirable to evacuate the passengers from the elevator car as soon as possible.

### SUMMARY

According to a first aspect of this disclosure, there is provided a robot capable of moving around at least a part of a building including an elevator landing area, the robot configured to interact with an elevator system in the building; the robot configured to receive at least one emergency notification from the elevator system; and the robot configured to interact physically with the elevator system as part of a rescue operation.

Using a robot as part of a rescue operation is advantageous as the robot can quickly and safely access the elevator system in a building, where otherwise passengers may have to wait a long period of time for assistance from maintenance personnel who may not be located in the building at the time of the emergency. The robot may be of any suitable type capable of moving freely at least around a part of a building, and with access to at least an elevator landing area. For example, a robot with wheels, a robot with tracks, an ambulatory robot, or a flying robot are all suitable. The robot may be dedicated to the purpose of assisting in a rescue, or it may be capable of carrying out other tasks. For example, outside of an emergency situation the robot may be a service robot being used in the building for other tasks. The robot may be configured to switch function when an emergency happens in the elevator system, e.g. it may switch to a rescue mode or an assistance mode.

The emergency notification may be a simple notice that an emergency situation has arisen. Such a message may be sufficient to cause the robot to take some action such as changing mode, ending a current task, moving to a particular location, requesting further information, etc. However, in some examples, the emergency notification may comprise at least one of: information about the type of emergency; location of emergency in the hoistway; and number of passengers trapped in an elevator car. The emergency notification may give specific details about the trapped passengers, for example presence of (or the number of) young children, the presence of (or the number of) disabled passengers and/or the presence of (or the number of) elderly passengers. Location information may be provided in the form of a height within the hoistway or it may be provided as a floor identifier (e.g. floor number) that is closest to the emergency (e.g. closest to the elevator car).

The robot may be configured to respond to the emergency notification by moving to the vicinity of the emergency, e.g. by moving to a landing of the elevator system at which (or near to which) the emergency has occurred. The robot will then be in a suitable position to interact physically with particular parts of the elevator system as part of the rescue operation. For example, the robot may be in a position to assist with the opening of doors and/or evacuating passengers. The robot may move the car to the nearest convenient floor before opening the doors and/or assisting passengers.

Not all faults within the elevator system will need a response from a robot. In some examples, no physical interaction is needed to make the elevator system safe for use e.g. a computer fault which can be fixed remotely. The robot may receive a first (e.g. preliminary) emergency notification relating to a potential need for a rescue operation. This notification may be transmitted as soon as a fault (or a certain category of faults) occurs. The robot may then begin to move towards a required or desired location where it can assist with a rescue operation. The robot may then receive a second emergency notification indicating a need for a rescue operation. In such examples, the robot may begin to move towards the required location and then not be required (e.g. if the fault is rectified remotely). The emergency notification may then be cancelled and the robot returned to other service. Alternatively, the robot may time out if the second notification is not received within a defined time period. If an emergency rescue operation is indeed required, the second notification will be sent and the robot will already be in position, or at least on its way to the position, thereby facilitating a rapid response.

In some embodiments, the robot is further configured to send information to the elevator system. The robot may send information regarding the robot's ability to respond to the emergency notification. For example, the robot may send an estimated time of arrival at a target location or an estimated time before a physical interaction can take place. This can help the system to estimate the time until a rescue operation can be attempted (or carried out). The robot may send information to the elevator system confirming that the physical interaction has occurred. This may confirm that a rescue operation has taken place, or that a certain stage of the rescue operation has taken place, or it may be used to inform the system to take further action as part of the rescue operation. The robot may also send a request for additional assistance. Additional assistance may be requested either from another robot, or human assistance may be requested. For example, an elevator maintenance worker, or a member of the emergency services may be specifically requested if required.

In some embodiments, the robot is configured to use an emergency elevator landing door key as part of the rescue operation Elevator car doors and elevator landing doors are locked when the elevator car is not present at the landing for safety reasons and elevator landing doors and elevator car doors automatically lock when the elevator car is ready to move away from a landing area. In an emergency situation, the elevator landing doors may need to be unlocked in order to free trapped passengers. To do so, an emergency door release is often triggered using an emergency landing door key. The robot may have an emergency landing door key built in (or as part of its standard equipment) so that it is immediately capable of unlocking the elevator landing doors when required. Alternatively, the robot may be configured to retrieve an emergency elevator landing door key from a given location in the building. For example, the robot may be able to retrieve the emergency landing door key from a secure storage located at a known location.

In some examples, the key may need to be fitted into a slot located high on an elevator landing door. Some robots may be tall enough to reach the slot. However, often robots are shorter than average height humans and so the robot may comprise an extendable arm for using the landing door key. The extendable arm may be arranged to extend to the height of the emergency door lock.

Elevator landing doors are often opened by means of the elevator car doors (the elevator car doors push on the elevator landing doors in order to move them). However, the elevator landing doors may not automatically open once the door lock has been released. Accordingly, manual opening may be required. Thus, the robot may also be configured to manually open the elevator landing doors once the key has unlocked the elevator landing doors. In some situations, energy failures may prevent the elevator car doors (and consequently the elevator landing doors) from opening. Thus, the robot may be configured to manually open the elevator landing doors and the elevator car doors simultaneously.

If the elevator car has become stuck between floors, the elevator car may need moving to a safe evacuation zone for the elevator car doors to be able to open. Safety systems may require the elevator car to be situated within a “Door Zone” close to a landing before the elevator car doors are capable of opening. The robot may interact with the elevator system to move the elevator car to a location suitable for facilitating the evacuation of passengers. For example, the robot may interact with the elevator system to cause the elevator car to move until it is within a Door Zone. It is highly desirable for any rescue operation to move the elevator car to be within the Door Zone. However, there are rare situations where this may not be possible. In such situations, evacuation of passengers may need to be via a trap-door in the elevator car ceiling (if one exists) and then via the elevator landing doors. In such cases, the robot may instruct passengers how to open the trap-door, the robot may open the landing doors above the elevator car and the robot may provide a ladder to assist passengers to climb from the elevator car roof to the landing doors. It will be appreciated that there may be other safety requirements in such situations and the robot may be able to assist with those.

In some examples, an elevator landing door lock may be released by means of a code entered on a landing operation panel (for example a particular sequence of presses on the up and/or down hall call buttons may release the landing door lock). Thus, in some examples the robot may be configured to interact with one or more elevator buttons as part of the physical interaction. For security reasons (e.g. to avoid passengers figuring out the code), such codes may need to be quite long and complex in order to be sufficiently safe. Robots are particularly well suited to storing and entering such codes precisely. In some examples, such a code may have a sequence length of ten or more button presses. In some examples, the code sequence may also require predefine timings between button presses. This is hard for a human to reproduce accurately, but easy for a robot to reproduce accurately.

The robot may be controlled by a central controller and given instructions on how and when to respond to the emergency by the central controller. However, in systems with a large number of robots, coordination of those robots can become hard. Therefore, in some examples, the robot may be an autonomous robot, e.g. one which is capable of operating largely based on its own sensors and internal processing. When the robot receives the emergency notification, the robot can make its own decisions about how to respond, e.g. how best to move to a target location.

In some embodiments, the robot may be one of a group of robots operating in a building. The group of robots may be individually controlled, or the group of robots may be controlled by a single central controller within the building. The robots may be partially autonomous, and partially controlled by a central controller. As noted above, in many examples, each robot of the group of robots may be autonomous.

In some embodiments, the robot is configured to communicate directly with at least one passenger as part of the rescue operation. Communication with passengers may be verbally via a speaker and microphone in the robot. For example, once the robot has moved to a landing adjacent to trapped passengers, the passengers may be able to hear the robot directly without requiring any additional communications equipment. This can be particularly beneficial in cases where power to the elevator system has been lost. For example, in severe cases, other communications equipment in the car may be faulty or non-functioning. In such cases, passengers may have no means of reassurance and no means to get updates about a rescue operation. Having a robot able to communicate with the passengers directly allows the robot to reassure the passengers that the emergency situation has been recognised and that a rescue operation is in progress. The robot may be able to provide simple reassurance to the passengers. However, in some examples, the robot may be able to provide additional information. For example, the robot may be configured to provide a current status of the rescue operation to at least one passenger. The robot may be able to inform passengers of the next step in the rescue operation (e.g. the arrival of maintenance personnel, or that the robot will attempt a rescue operation itself, or that the doors are about to be opened). The robot may be able to provide an estimate time until the next stage of the rescue operation, e.g. an estimate time before the doors can be opened or an estimated time until maintenance personnel arrive.

The robot may be configured to answer questions from the at least one passenger. For example, when passengers get anxious about their situation, they may wish to ask for continued reassurance that the rescue is underway. Passengers may therefore ask the robot what will happen next or may ask when they will be released. The robot may be pre-programmed with set questions that can be answered. Alternatively, the robot may comprise an artificial intelligence that can attempt to parse a question from a passenger and provide a suitable answer. The artificial intelligence may be trained in advance based on frequently asked questions in a variety of emergency situations. The robot may therefore be able to provide a suitable answer based at least on the question that has been asked and a type of emergency situation that has been established.

The robot may be able to ask passengers to provide information. For example, the robot may be able to ask for useful information like the number of passengers present within the elevator car and whether any of those passengers are injured and/or vulnerable. This information may be used by the robot to influence the rescue operation. For example, the robot may use this information to call emergency services and/or to request a high priority rescue.

The robot may be arranged to communicate with passengers in other ways (in addition to, or as an alternative to direct communication via speaker/microphone). For example, the robot may be able to communicate with passengers via a passenger's mobile device. For example, if the robot is within range for short range communication protocols such as Bluetooth, the robot may be able to contact the mobile devices of passengers that are trapped within the elevator car and may be able to establish a text or voice communication with those passengers. Additionally, or alternatively, the robot may be arranged to contact passengers via a communication panel in the elevator car. For example, where there is a speaker and/or a display within the elevator car, the robot may be able to send messages through the elevator car's speaker and or display messages on the elevator car display. Passengers may be able to respond via a microphone within the car and/or by answering questions using the buttons within the car, e.g. buttons on an elevator call panel, or a touchscreen. By way of example, the passengers may be able to use numbered floor buttons to answer multiple choice questions or to input a number of people in the car. Alternatively, a single button can be used for yes/no questions using a code such as “once for yes, twice for no”. In other examples, a touchscreen may be provided in the elevator car which can allow information to be provided to the passengers as well as allowing data entry by the passengers. For example, the touchscreen may provide information (e.g. a map) about the location of the robot, the next stage in the rescue (e.g. which direction the elevator car will move and/or estimated time until evacuation). Passengers may be able to enter information on the touchscreen about the number of passengers, the number of elderly passengers, the number of children, any injuries or need for medical help, etc.

According to a second aspect of this disclosure, there is provided an elevator system comprising: an elevator car; a hoistway; a plurality of landing areas with corresponding elevator landing doors; and at least one robot as described above (optionally including any of the optional features described above).

In some embodiments, the elevator car has a car operating panel and the at least one robot is configured to communicate with passengers in the elevator car via the car operating panel as part of the rescue operation. As discussed above, the robot may talk to the passengers via an in-car speaker/microphone; or the robot may communicate via a display or touchscreen in the elevator car. The elevator car may comprise a screen, which may be a touchscreen. The screen may provide information to the passengers regarding the rescue operation.

The elevator system may also send data from elevator car sensors to the at least one robot. The sensors may include video cameras located in the elevator car. The robot may determine a number of passengers trapped in the elevator car or health/well-being information regarding passengers in the elevator car by using data from the sensors in the elevator car, or using feedback from passengers using a touchscreen or car operating panel.

The system features described herein with respect to the robot and the elevator system are equally applicable to the below described method, and vice versa.

According to a third aspect of the present disclosure, a method of rescuing passengers from an elevator system using at least one robot is provided, the method comprising:

The at least one robot receiving an emergency notification from an elevator system; and the at least one robot physically interacting with the elevator system as part of the rescue operation.

In some embodiments, the method further comprises: the at least one robot moving to an elevator landing area. The physical interaction may then comprise any of: unlocking elevator landing doors, opening elevator landing doors, unlocking elevator car doors, opening elevator car doors, assisting passengers to exit the elevator car.

In some embodiments, the method further comprises: detecting an emergency situation in an elevator system; and sending the emergency notification from the elevator system to at least one robot. Elevator systems may have sensors and/or systems that can detect where a fault has occurred and/or where the elevator car is located when a fault has occurred. In some situations, the fault can be classified as an emergency situation, and the elevator system can send an emergency notification to the at least one robot. As discussed above, the notification may include information on the location of the elevator car.

In some embodiments, the method further comprises: detecting a location of the emergency situation in an elevator system; determining a closest safe floor to the emergency situation; sending the emergency notification from the elevator system to at least the most suitable robot to the closest safe floor; and moving at least the most suitable robot to the corresponding landing area on the closest safe floor. As discussed above, there may be multiple robots within a building which are capable of responding to an emergency in the elevator system. There are a number of factors which may be used to determine the most suitable robot to respond to the emergency notification. The most suitable robot may be the robot configured to interact with the elevator system in a manner which can aid with the required rescue operation. For example, some robots in the building may be configured to use an emergency elevator landing door key, whilst others may not. In some examples, the most suitable robot may be the closest robot. In some examples, the most suitable robot may be determined from available information (e.g. sensors within the building, or position information provided by the robots themselves). In other examples, the robots may all receive the emergency notification and may agree between them (by further communication) which robot is most suitable. For example, if the emergency notification indicates that an emergency door lock key will be needed, a robot with an emergency door lock key may be selected, even if it is not the closest in distance. In other examples, a robot that has free capacity or a robot that will be finished its current task soonest may be selected as the robot to respond to the emergency situation. It will be appreciated that where robots have other tasks, they may not be in an immediate position to respond safely until they have finished their current task. Therefore, another robot that is further away in distance may still be the most suitable robot to respond to the emergency notification.

The elevator system can detect a location of the emergency situation in a variety of ways, including with internal feedback, and safety sensors. Having determined that an emergency has occurred, the location of said emergency may be determined in order to direct a rescue operation. The robot can then move to the closest safe floor for the passengers to evacuate from an elevator car. The closest safe floor may be on the floor above the elevator car in the hoistway, or the closest safe floor may be on the floor below the elevator car in the hoistway. The closest safe floor can be determined by determining which way the elevator car will move when the safety brakes are released. The elevator system or the robot may determine which way the elevator car will move when the safety brakes are released by considering at least one of: the weight of the elevator car, the weight of the counterweight, and the location where the elevator car is stuck within the hoistway. If the elevator car needs to be moved before passengers can be evacuated, the robot may interact with the elevator system to facilitate the safe movement of the elevator car to a suitable evacuation location. For example, moving the elevator car during a rescue mode may involve causing a brake to be released for a period of time. The movement may need to be controlled to avoid an unwanted speed increase of the elevator car. Thus the brake may need to be repeatedly released and reapplied to control the movement of the elevator car without overspeed. The robot may be configured to perform this operation and thereby cause controlled movement of the elevator car towards a landing. The robot may interact with the elevator system physically and/or the robot may interact with the elevator system using electronic communications as part of this process. The communications may be long or short range wireless communications, e.g. Bluetooth or Wi-Fi or NFC or the robot may communicate with the elevator system via cloud services. The robot may interact with the elevator system physically via a control panel, e.g. by pressing a button to cause the brake to release. Once the elevator car has reached a Door Zone, the robot may stop interacting with the elevator system to move the elevator car and may proceed to interact with the elevator landing doors and or the elevator car doors and to assist passengers with exiting the elevator car.

In some embodiments, the elevator system may have an electronic re-call system which comprises batteries and is capable of moving the elevator car in the case of power failures or other system failures. This system may be used in the evacuation process to move the elevator car by engaging with the elevator system electrically. For example, the robot may interact physically with the elevator system to effect movement of the car, e.g. the robot may use a special key or press buttons (e.g. on a control panel) to cause movement of the car in the up/down direction. Movement of the elevator car can be monitored during this process. As an alternative, or in addition, the robot may activate this re-call system and/or otherwise effect movement of the elevator car via wireless communications, e.g., Bluetooth or Wi-Fi or NFC or via cloud services.

The robot may be arranged to use this re-call system to move the elevator car to the nearest convenient floor. A particular advantage of this system is that the movement can be made in any direction since the batteries provide power to move the elevator car. Therefore, the direction of movement need not be limited based on the weight of the elevator car. The nearest convenient floor may be chosen to get the elevator car at the Unlocking Zone area (or Door Zone area). However, the most convenient floor may not always be the nearest. For example, the elevator car may be moved to a floor with a building exit or a floor with better medical assistance.

In some embodiments, the method further comprises: alerting the at least one robot to a potential emergency with a first emergency notification; and indicating that at least one robot should respond to the emergency with a second emergency notification.

In some embodiments, the method further comprises: sending a rejection notification from a first robot to the elevator system indicating that the robot is unable to help in a rescue operation; and sending an emergency notification from the elevator system to a second robot. This ensures that if a robot is unable to aid with the rescue operation, another robot will move to help with the rescue operation. As discussed above, the first robot may be occupied with other tasks or it may be blocked from moving to the target location. The first robot may be unable to help with a specific rescue operation (while still being capable of helping with other rescue operations). For example, the robot may be unable to reach the required location of the rescue operation. By way of example, due to its location, a robot may be able to assist with emergencies in one hoistway (e.g. on one side of a building), but not in another hoistway (on the opposite side of the building).

The robot may determine, using information from the emergency notification, how best to physically interact with the elevator system as part of a rescue operation. The robot may determine that an emergency elevator landing door key needs to be used. The robot may retrieve an emergency landing door key (e.g. from a known location) to use to unlock the elevator landing doors. The robot may use an extendible arm to use the emergency landing door key. The robot may determine that the elevator landing doors need manually opening. The robot may manually open the elevator landing doors.

The method may further comprise the robot communicating with passengers in an elevator car as part of the rescue operation. The robot may communicate with passengers in an elevator car by any of the ways discussed above, e.g. via an elevator car operating panel or a touchscreen. The robot may communicate with passengers via a passenger mobile device. The robot may communicate with passengers verbally via a microphone and speaker. The robot may respond to information or requests provided by a passenger as part of the rescue operation.

### DRAWING DESCRIPTION

Certain preferred examples of this disclosure will now be described, by way of example only, with reference to the accompanying drawings, in which:

FIG. 1 is a schematic illustration of an elevator system that may employ various embodiments of the present disclosure;

FIG. 2 is a schematic illustration of a robot physically interacting with an elevator system in accordance with various embodiments of the present disclosure;

FIG. 3 shows a flow chart representing a method rescuing passengers from an elevator system in accordance with various embodiments of the present disclosure;

FIG. 4 shows a flow chart representing method steps performable by the elevator system in accordance with various embodiments of the present disclosure.

### DETAILED DESCRIPTION

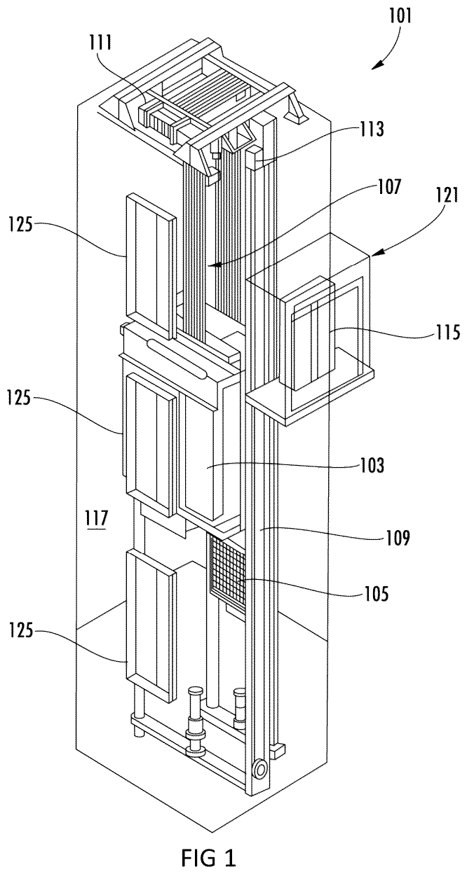

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including a tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

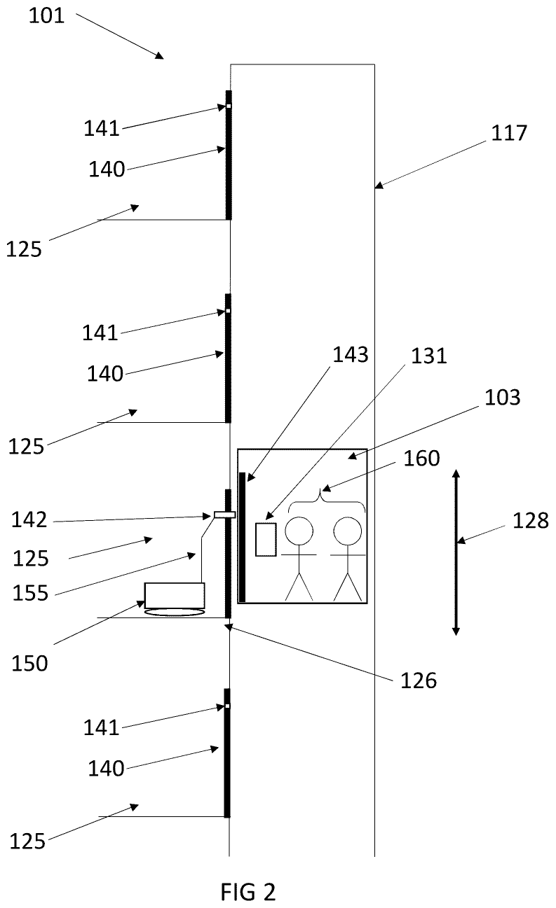

FIG. 2 is a schematic illustration showing a robot 150 interacting with an elevator system 101. The elevator system 101 shows passengers 160 in an elevator car 103 in the hoistway 117. The elevator car 103 is stopped and immobile between two landing areas 125. A car operating panel 131 is shown in the elevator car 103. Each landing area 125 has elevator landing doors 140 with a key hole 141 for using an emergency elevator landing door key 142. A robot 150 is shown on the closest safe floor 126, using the emergency elevator landing door key 142 with an extendible arm 155.

In the example of FIG. 2 the elevator car 103 has become stuck between two floors. The robot 150 has received an emergency notification, and is undergoing a rescue operation to evacuate the passengers 160 from the elevator car 103. The robot 150 has moved to the closest safe floor 126, and is physically interacting with the elevator system 101 by using the emergency elevator landing door key 142. In this example, the robot 103 is of short stature and therefore in order to be able to reach the key hole 141 for using the emergency elevator landing door key 142, it is using an extendible arm 155.

FIG. 2 shows the elevator car 103 in a position relatively close to the safe floor 126. The elevator car 103 may have been moved here by the robot using a rescue procedure to release the brakes and control the speed of the elevator car 103 until it is in a suitable rescue position. In FIG. 2, the elevator car 103 is close enough to the floor 126 that the elevator car doors 143 are within the door zone 128 which is the zone in which the elevator car doors 143 become unlocked and can be opened manually once the robot 150 has unlocked the elevator landing doors 140 with the landing door key 142. From this position, the passengers 160 will be able to leave the elevator car 103 with only a small step down to the floor 126.

It will be appreciated by those skilled in the art that the same rescue operation could be performed by various different types of robot 150, not limited to a short stature robot that is low to the ground. Other example robots include humanoid robots and flying robots. The emergency elevator landing door key 142 may be an integral part of the robot 150, or the robot 150 may have collected an emergency elevator landing door key 142 from elsewhere in the building (e.g. a safe storage location) to perform the rescue operation.

The robot 150 can communicate with the passengers 160 in the car 103. This communication can be to inform the passengers that a rescue operation is occurring. The robot 150 can have an inbuilt speaker and microphone to talk directly with the passengers 160. In some examples, the robot 150 can talk to the passengers 160 via the car operating panel 131. This can be especially useful if the robot 150 is too far away from the passengers 160 for them to be able to hear or speak to the robot 150 directly. The robot 150 can reassure the passengers 160 that the emergency situation is being handled and can inform them of the likely next steps and/or likely time scales. This can help to calm the passengers 160 and reassure them that they will soon be released from their situation. The robot 150 may be able to ask questions of the passengers 160, e.g. to obtain information on the number of passengers 160 trapped in the elevator car 103 and whether any passenger is injured or vulnerable (e.g. a child or elderly person). The robot 150 can communicate this information to the elevator controller 115 or directly to other emergency services. For example, the robot 150 may be in communication with a building manager or it may be able to call for medical assistance or additional rescue assistance. The robot 150 may additionally be able to answer questions from the passengers 160. The robot may have an artificial intelligence able to process questions from the passengers and provide suitable answers based on a database of previously learned questions and answers.

It will be appreciated by those skilled in the art that FIG. 2 shows an example rescue operation, however the robot 150 may be able to action various other rescue operations by physically interacting with the elevator system 103 in other ways. For example, the robot 150 may be able to open the elevator landing doors 140 and/or the elevator car doors. The robot 150 may be able to deploy safety equipment adjacent to the elevator landing doors 140 for safety of other persons while the rescue operation is underway. The robot 150 may be able to cause the elevator car 103 to move closer to the safe floor 126. The robot 150 may be able to assist passengers 160 in stepping down from the elevator car 103 onto the landing floor 126.

In the example of FIG. 2 only one robot 150 and elevator system 101 is shown. Whilst a building may only have one robot 150 (or only one robot capable of assisting in an elevator rescue operation), it is envisaged that a building may have numerous robots 150 normally assigned to different tasks within a building and each also capable of assisting in an elevator rescue operation. Equally, many buildings may have a plurality of elevator systems. Each of the robots can be configured to respond to an emergency in an elevator system 101 in addition to the robots' normal duties (e.g. as service robots or cleaning robots). Additionally, in buildings with multiple elevator systems the robots 150 could help with an emergency in any elevator system 101 that they can access. In some buildings robots 150 can move between floors of the building, however in some buildings a robot may be assigned to a single floor. In such cases, the emergency notification may be directed at specific robots, e.g. to robots on the safest floor 126.

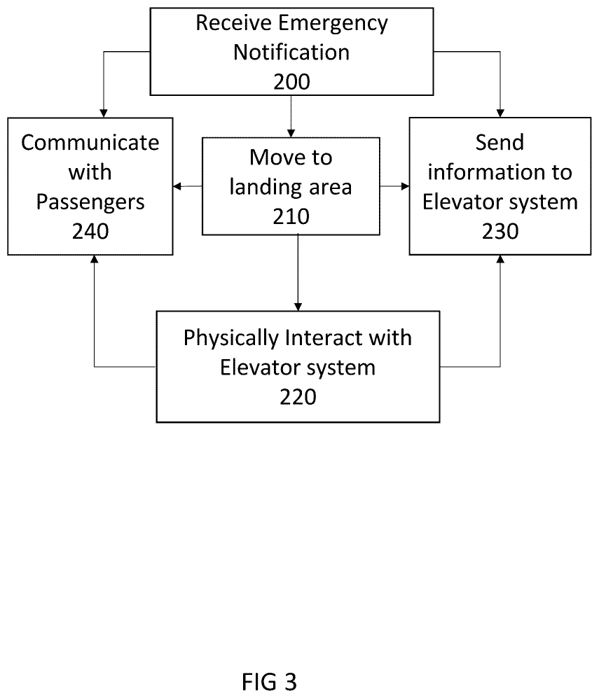

FIG. 3 shows a method for a robot 150 to respond to an emergency situation in the elevator system 101. At step 200 the robot 150 receives an emergency notification from the elevator system 101. If required, at step 210 the robot 150 moves to the landing area. The robot 150 may already be at the relevant location, so movement of the robot may not be necessary. At step 220 the robot 150 physically interacts with the elevator system 101 as part of the rescue operation, in the example of FIG. 2 this physical interaction can be using the emergency elevator landing door key 142. Step 230 shows that at any stage the robot 150 may send information back to the elevator system 101. The information can include details about the rescue operation. The information can be that the robot 150 cannot respond to the emergency or it may be updates on the status of the rescue, e.g. current location, determined number and health of passengers, etc. At step 240 the robot can communicate with passengers 160 that need help during the rescue operation. This communication with the passengers 160 can happen at any stage during the method. The robot 150 can communicate directly with the passengers 160 (i.e. via speaker and microphone, without any intervening communication devices), or via other systems within the building e.g. a car operating panel 131 in an elevator car 103. The robot 150 may establish communication via a passenger's personal mobile device, e.g. via a cellular call or via short range radio services such as Bluetooth. The robot 150 can determine, based on information provided in the emergency notification, how to respond to the emergency. This determination may be that the robot 150 is not able to action a rescue operation. The robot 150 may pass the rescue operation on to another robot 150, either directly or indirectly (e.g. via the elevator system 101, a centralized robot management system, or any other suitable system).

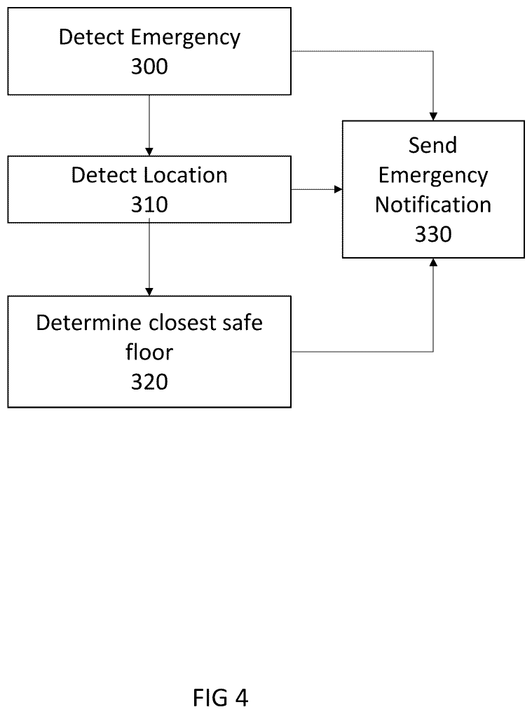

FIG. 4 shows parts of a method which may be performed by the elevator system 101. At step 300 the elevator system 101 detects an occurrence which it classifies as an emergency. The emergency may be the detection of a fault, or any other event which can be classified as an emergency. At step 310 the elevator system 101 can detect a location of the elevator car 103. At step 320 the closest safe floor 126 can be determined. At step 330 an emergency notification is sent from the elevator system 101 to at least one robot 150 in the building. The elevator system 101 may send the emergency notification only to a robot 150 that it has determined as the closest or most appropriate robot 150, e.g. a robot 150 on the closest safe floor 126. The elevator system 101 may send the emergency notification to all of a plurality of robots 150 in a building, and the plurality of robots 150 may determine which robot 150 will respond to the emergency notification. The elevator system 101 may send multiple emergency notifications at any of steps 300, 310 or 320 giving information about the emergency to the robots 150 in a building. The elevator system 101 may send a first notification to inform the robot(s) 150 of a potential emergency, and a second notification to indicate that assistance is required. The first notification can be sent to all robots 150 and allows the robots 150 to select an individual for response and to begin moving towards a target location while the nature of the emergency is investigated further. The second notification may be sent once it has been established that assistance is definitively required. At this point a single robot 150 may have been selected for assistance and may already be on its way to the elevator landing 126. The second notification may be sent to all robots 150, but may instead be sent just to the single selected robot 150.

Whilst the steps of FIG. 4 have been described as being performed by the elevator system 101, any other suitable system, or multiple systems, may action the steps of the method of FIG. 4, for example a building system that monitors multiple different systems within a building, or a centralized robot management system. The robot 150 may be capable of taking information provided by the elevator system 101 in an initial emergency notification, and detecting a location of the emergency and/or determining the closest safe floor 126 itself. At any stage a robot 150 may determine that it is not capable of actioning a required rescue operation, and the robot 150 may pass the rescue operation to another robot 150 or may call for assistance from building or maintenance personnel.

It will be appreciated by a person skilled in the art that the steps of the method here described can be actioned by various computing devices. In some examples the robots 150 are at least partially controlled by an artificial intelligence (AI) system. Training of the AI system can be done by elevator maintenance personnel inputting various known emergency scenarios into the system. Additional training can occur by using robots 150 alongside maintenance personnel for a given training period or by training them on data acquired during such incidents. It will be appreciated by the skilled person that multiple additional uses for the AI technology exist in the method steps herein described, including determining what sort of rescue operation to perform, and how to interact with the passengers whilst they are trapped in an elevator car 103.

It will be appreciated that the systems and methods described herein have numerous advantages over the state of the art. The use of robots in rescue operations can increase the safety of the passengers whilst enabling a much quicker rescue as the passengers would not have to wait for assistance from a person not based in the building where an emergency has occurred. Additionally, the ability of the robot to communicate with the passengers, especially directly, allows the robot to reassure and calm passengers who may be nervous or agitated while trapped.

It will be appreciated by those skilled in the art that the disclosure has been illustrated by describing one or more specific aspects thereof, but is not limited to these aspects; many variations and modifications are possible, within the scope of the accompanying claims.

What is claimed is:

1. A robot (150) capable of moving around at least a part of a building including an elevator landing area (125), the robot (150) configured to interact with an elevator system (101) in the building;
the robot (150) configured to receive at least one emergency notification from the elevator system (101); and
the robot (150) configured to interact physically with the elevator system (103) as part of a rescue operation.

2. A robot (150) as claimed in claim 1, wherein the robot (150) is further configured to send information to the elevator system (101).

3. A robot (150) as claimed in claim 1, wherein the robot (150) is configured to use an emergency elevator landing door key (142) as part of the rescue operation.

4. A robot (150) as claimed in claim 1, wherein the robot (150) is an autonomous robot.

5. A robot (150) as claimed in claim 1, wherein the robot (150) is further configured to communicate directly with at least one passenger (160) as part of the rescue operation.

6. A robot (150) as claimed in claim 5, wherein the robot (150) is configured to provide a current status of the rescue operation to the at least one passenger (160).

7. A robot (150) as claimed in claim 5, wherein the robot (150) is configured to answer questions from the at least one passenger (160).

8. An elevator system (101) comprising:
at least one elevator car (103);
a hoistway (117);
a plurality of landing areas (125) with corresponding elevator landing doors (140); and
at least one robot (150) as claimed in claim 1.

9. An elevator system (101) as claimed in claim 8, wherein the elevator car (103) has a car operating panel (131) and wherein the at least one robot (150) is configured to communicate with at least one passenger (160) in the at least one elevator car (103) via the car operating panel (131) as part of the rescue operation.

10. A method of rescuing passengers (160) from an elevator system (101) using at least one robot (150); the method comprising:
the at least one robot (150) receiving an emergency notification from the elevator system (101); and
the at least one robot (150) physically interacting with the elevator system (101) as part of the rescue operation.

11. A method as claimed in claim 10, wherein the method further comprises:
the at least one robot (150) moving to an elevator landing area (125).

12. A method as claimed in claim 10, wherein the method further comprises:
detecting an emergency situation in an elevator system (101); and
sending the emergency notification from the elevator system (101) to the at least one robot (150).

13. A method as claimed in claim 11, wherein the method further comprises:
detecting a location of the emergency situation in an elevator system (101);
determining a closest safe floor (126) to the emergency situation;
sending the emergency notification from the elevator system (101) to at least the most suitable robot (150) to the closest safe floor (126); and
moving at least the most suitable robot (150) to the corresponding landing area (125) on the closest safe floor (126).

14. A method as claimed in claim 13, wherein the method further comprises:
alerting the at least one robot (150) to a potential emergency with a first notification; and
indicating that the at least one robot (150) should respond to the emergency with a second notification.

15. A method as claimed in claim 10, wherein the method further comprises:
sending a rejection notification from a first robot (150) to the elevator system (101) indicating the first robot (150) is unable to action a rescue operation; and
sending an emergency notification from the elevator system (101) to a second robot (150).
